(19) United States
(12) Patent Application Publication
(10) Pub. No.: US 2017/0025195 A1
(43) Pub. Date: Jan. 26, 2017

(54) SCANNER FOR RODS

(71) Applicant: TECNATOM, S.A., Madrid (ES)

(72) Inventor: Pablo Jesús PIÑEIRO FERNÁNDEZ, Madrid (ES)

(73) Assignee: TECNATOM, S.A., Madrid (ES)

(21) Appl. No.: 15/213,909

(22) Filed: Jul. 19, 2016

(30) Foreign Application Priority Data
Jul. 21, 2015 (ES) P201531074

(51) Int. Cl. G21C 17/06; G21C 19/00

(52) U.S. Cl. CPC G21C 17/06; G21C 19/00

(57) ABSTRACT

Scanner for fuel rods has inspection devices for rods, transport devices to displace the rod throughout the scanner, and indicator devices to generate a signal indicative of a result of a scan corresponding to a scanned rod.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention is included in the field of equipment to perform quality controls on fresh fuel rods.

2. Description of Related Art Including Information Disclosed Under 37 CFR 1.97 and 37 CFR 1.98.

Equipment is known for performing non-destructive inspections or quality controls on nuclear fuel rods.

ES 2056952—translation of EP0356701A2, which claims priority of U.S. Pat. No. 238,659—shows a system and a method for non-destructive inspections of nuclear fuel rods with gadolinium content (“poisoned”) and pure uranium (“non-poisoned”). It has a series of duplicated elements, each one of them placed in a corresponding channel: the poisoned rods are inspected in one channel and the non-poisoned rods are inspected in the other.

U.S. Pat. No. 5,108,692A, divisional of U.S. Pat. No. 238,659 is centred on the system disclosed in U.S. Pat. No. 238,659.

DE4017100A1, ES441130A1, ES2030774T3, JP61187679, JP 4029083, TW200915345, KR 20110072731 disclose passive-type systems.

ES 2056952, EP0356701A2, U.S. Pat. No. 5,108,692A or U.S. Pat. No. 238,659 indicate that a first solution in the non-destructive determination of the enrichment concentration of a non-poisoned rod, includes the “passive scanning” method, wherein it quantitatively detects the gamma rays of a characteristic energy emitted during the natural radioactive disintegration of the fissionable material such as U-235. Since U-235 has a relatively long half-life period, its spontaneous decay and consequent gamma ray emission are low. In consequence, the scanning time necessary for the quantitative analysis of the enrichment was extremely long, even when the rods were scanned by a distributed matrix of gamma ray detectors, accumulating their calculations. Since all the rods have to be tested, the manufacturing production is drastically reduced due to this passive scanning solution.

### BRIEF SUMMARY OF THE INVENTION

The invention relates to a scanner for fuel rods such as that defined in claim 1. The dependent claims define additional characteristics of the scanner. The invention resolves the drawbacks unresolved in the state of the art arising from the characteristics defined in the dependent claims.

In particular, the scanner for fuel rods comprises:
a) inspection means of rods;
b) transport means to displace the rod throughout the scanner; and also comprises:
c) indicator means to generate a signal indicative of a result of a scan corresponding to a scanned rod;
d) auxiliary means selected from: fairing means; air-conditioning means; rod dust collection means; signal processing means; and combinations thereof.

The invention also relates to a scanning method of fuel rods comprising:
a) inspecting by inspection means a rod to be inspected to obtain a scanning result of a scanned rod;
b) assigning a signal selected from admissible rod, inadmissible rod and checkable rod to a scanned rod in accordance with the scanning result.

Variants and specific forms of embodiment are described below and in other parts of the description.

Thus, the scanner can emit the indicative signal selected from admissible rod, inadmissible rod and checkable rod. Preferably the scanner will contain acceptance, rejection and inspection baskets for each type of rod.

Likewise, the transport means of the rod shall be preferably three or more drive points of the rod, synchronized and aligned according to a longitudinal axis parallel to a longitudinal axis of the rod, generally distanced from one another by a distance less than one half of a length of bar to avoid a contact of the rod with a fixed part of the scanner.

The drive points shall comprise a pressure wheel configured to press the rod against at least one driving wheel configured to drive the rod, and where applicable an optional idle rotation wheel.

The transport means shall be defined with a rated speed configured to fulfil precision requirements in a scanning result, although they can preferably achieve higher or lower speeds:
a) a re-scanning speed, slower than the rated speed;
b) a high speed, faster than the rated speed;

Likewise, the scanner will have rod dust collection means configured to collect dust from the rod generated in the scanner and obtain collected dust. They will have hoppers, pneumatic evacuation systems (with suction and evacuation lines)

Furthermore, the following are cited as inspection means:
a) an instrumentation block (densitometer, gadolinium meter, fault detector for detecting faults in the container tube and/or profilometer);
b) a gamma block (with a series of independent gamma detectors);
c) an identification block of the rod; and combinations thereof

### BRIEF DESCRIPTION OF THE SEVERAL VIEWS OF THE DRAWINGS

For a better understanding of the invention, drawings are attached, wherein, only by way of example, different embodiments of the invention are represented.

FIG. 1 shows the identification block, the acceptance, rejection, inspection baskets and other scanner components.

FIG. 2 shows a rod displaced by the transport means and its components.

FIG. 3 shows the instrumentation block.

FIG. 4 shows the gamma block.

FIG. 5 shows the dust collection means.

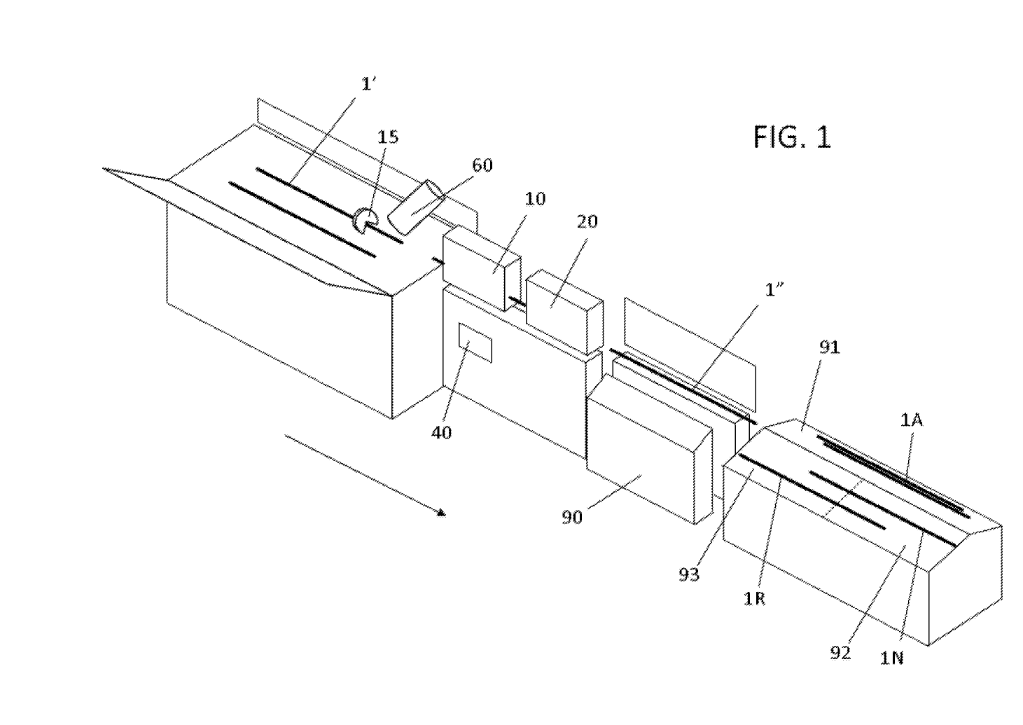

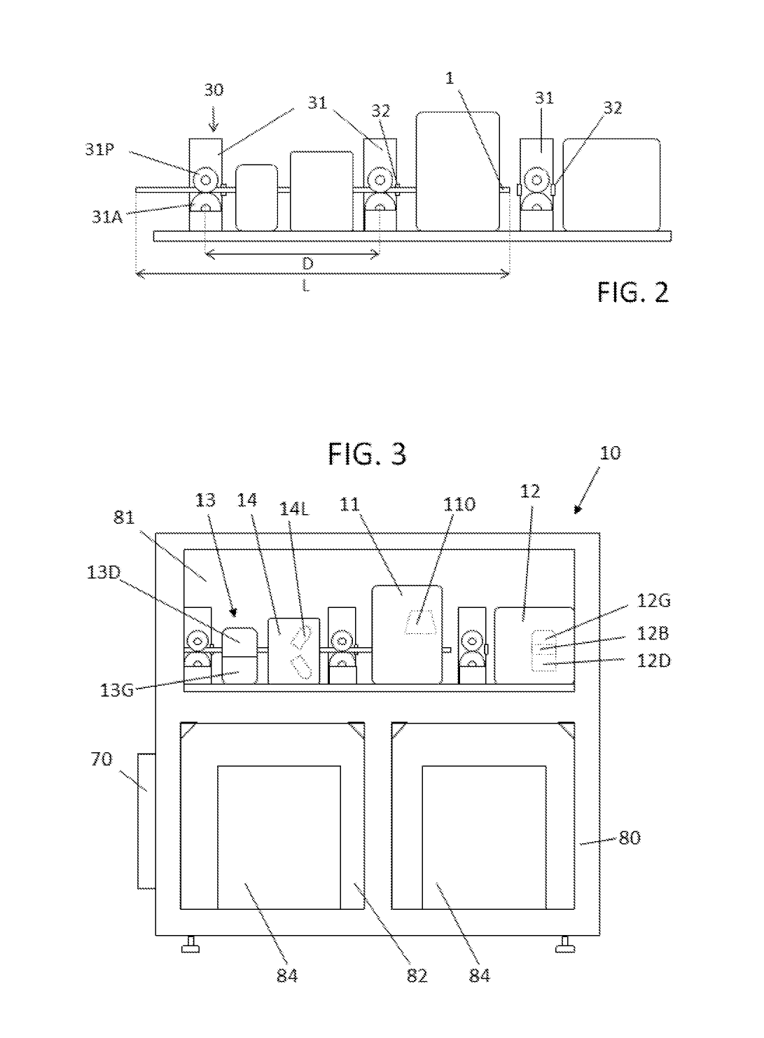

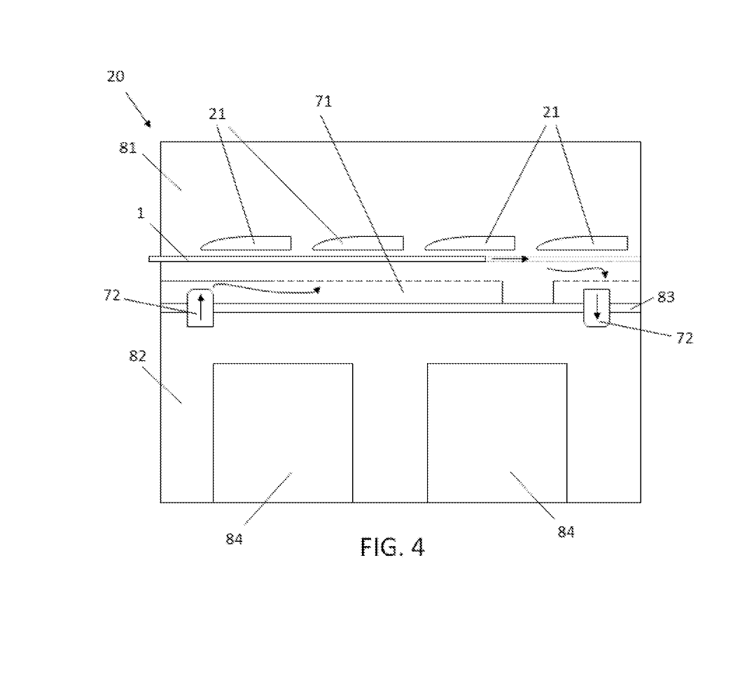

The references used are:

rods (1)

rod to be inspected (1′)

scanned rod (1″)

admissible rod (1A)

inadmissible rod (1N)

checkable rod (1R)

inspection means (10, 20, 60)

instrumentation block (10)

gamma block (20)

gamma detectors (21)

identification block (60)

indicator means (40)

transport means (30)

drive points (31)

driving wheel (31A)

pressure wheel (31P)

distance (D)

length (L)

passage detector (32)

dust collection means (50)

collected dust (50R)

suctioned dust (50S)

hopper (51)

pneumatic system (52)

suction line (521)

evacuation line (522)

densitometer (11)

source of gamma radiation (110)

gadolinium meter (12)

magnetic generator (12G)

magnetic field (12B)

first induction current generator (12D)

fault detector (13)

current generator (13G)

second induction current generator (13D)

profilometer (14)

laser emitters (14L)

reading means (15)

air-conditioning means (70)

pipes (71)

fans (72)

fairing (80)

inspection enclosure (81)

auxiliary enclosure (82)

separation means (83)

signal processing means (84)

acceptance basket (91)

rejection basket (92)

inspection basket (93)

storage means (90)

### DETAILED DESCRIPTION OF THE INVENTION

A first aspect of the invention relates to a scanner for fuel rods (1) comprising inspection means (10, 20, 60) of rods (1); transport means (30) to displace the rod (1) throughout the scanner; indicator means (40) to generate a signal indicative of a result of a scan corresponding to a scanned rod (1″); and auxiliary means selected from: fairing means (80), air-conditioning means (70), rod (1) dust collection means (50), signal processing means (84) and combinations thereof

The signal processing means (84) may comprise systems with electronics integrated in the blocks which constitute the inspection means (10, 20, 60) avoiding cables and external connectors.

In accordance with other characteristics of the invention:

The indicative signal is selected from admissible rod (1A), inadmissible rod (1N) and checkable rod (1R), as shall be explained below.

The transport means (30) of the rod (1) comprise three (or more) drive points (31) of the rod (1) aligned according to a longitudinal axis parallel to a longitudinal axis of the rod (1).

The drive points (31) are distanced from one another by a distance (D) less than one half of a length (L) of rod (1) to avoid a contact of the rod (1) with a fixed part of the scanner, as each rod (1) rests at all times on at least two drive points (31). For example, the distance (D) shall be less than 600 mm.

The three drive points (31) are synchronized to guarantee uniformity in the drive of the rod (1). This characteristic is also very important to maintain a uniform displacement speed of the rod (1) and so that no tugs occur in the rod drive.

A drive point (31) comprises a rod passage detector (32)(1), which will be preferably inductive and disposed horizontally. There may be passage detectors (32) for each drive point (31). The drive points (31) can also be called drive units. The passage detectors (32) allow a precise measurement of the rod (1) passage speed which will be used by fault detection means to identity the fault position accurately. The precise measurement of the rod passage speed (1) shall be performed by calculation means designed for this effect.

The drive points (31) comprise a pressure wheel (31P) configured to press the rod (1) against at least one driving wheel (31A) configured to drive the rod (1) (actuated by its own motor unit, or by one share with the other driving wheels (31A));

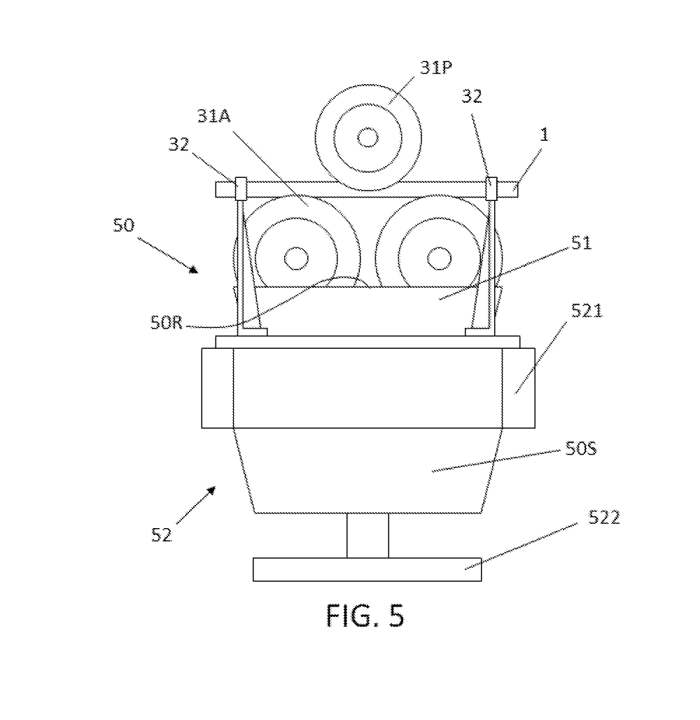

The configuration of the drive points (31), where the rod (1) is driven between the driving wheel (31A) and the pressure wheel (31P), guarantees that the rod is displaced without sliding. The driving wheel (31A) may be underneath the rod and the pressure wheel (31P) above the rod to, between the two wheels (31A, 31P), drive the wheel without sliding. It is possible to install two driving wheels (31A) or one driving wheel (31A) and a second wheel of adjacent idle rotation to improve the grip against the pressure wheel (31P) which is positioned between the two, as observed in FIG. 5.

The driving wheels (31A) or the pressure wheel (31P) can have marks to visually check if they are rotating correctly.

The transport means (30) of the rod (1) comprise: a rated speed (e.g. of 60 mm/s) configured to fulfil precision requirements in a scanning result.

The transport means (30) of the rod (1) further comprise a speed selected from: a re-scanning speed, slower than the rated speed; a high speed, faster than the rated speed, and combinations thereof.

The re-scanning speed is useful for re-scanning checkable rods (1R), i.e. rods which have not fulfilled the scanning requirements but the result of which advises re-scanning before rejecting the rod (1). The high speed is useful for special rod scans or to increase scanner productivity.

The rod (1) dust collection means (50) are configured to collect dust (50) from the rod (1) generated in the scanner and obtain collected dust (50R). They may comprise a hopper (51) underneath a drive point (31). There may be a hopper (51) underneath each drive point (31) to collect the maximum dust generated. Where applicable, these hoppers (51) can have extensions to capture the dust generated in other scanner points.

The dust collection means (50) may also comprise a pneumatic system (52) configured to evacuate the collected dust (50R). In one embodiment, this pneumatic system (52) comprises a suction line (521) configured to generate a suction in the hopper (51) aspirating the collected dust (50R) obtaining suctioned dust (50S) and an evacuation line (522) configured to evacuate the suctioned dust (505).

The inspection means (10, 20, 60) comprise a block selected from an instrumentation block (10), a gamma block (20), an identification block (60) and combinations thereof.

The instrumentation block (10) comprises a device selected from: a densitometer (11); a gadolinium meter (12); a profilometer (14); a fault detector (13), where the faults are selected from lack of material, perforations or cracks in the sheath or outer container tube (normally of Zircaloy) containing the pellets of fuel and combinations thereof

The densitometer (11) would comprise a source of gamma radiation (110) configured to obtain an x-ray of the rod (1).

The gadolinium meter (12) comprises for its part a magnetic generator (12G) to generate a magnetic field (12B) and a first induction current generator (12D) to detect induction currents generated by the magnetic field (12B). The gadolinium meter (12) is configured to measure gadolinium doping contained in the pellets of the fuel rod (1). The induction current generator (12D) measures the variation in the induction currents generated by the magnetic field (12B) and thus it quantifies the gadolinium content in the fuel pellets. The fuel pellets may be uranium.

The fault detector (13) comprises: a current generator (13G) to generate induction currents in the fuel rod (1) and a second induction current generator (13D) to detect induction currents generated in the fuel rod (1). The currents induced in the fuel rod (1) enable detecting faults and guarantee that there are no cracks or fractures in the metal sheath of the rod (1).

The profilometer (14) comprises laser emitters (14L), normally four disposed to measure four diameters in four different directions of the fuel rod (1). The profilometer (14) may be an apparatus that measures 4 diameters of the rod in different orientations. By performing measurements of diameters in different orientations of the rod throughout its length, since the rod (1) is displaced throughout the scanner, it can obtain a measurement of the cylindrical nature of the rod (1).

The gamma block (20) comprises a plurality of electronically synchronized gamma detectors (21), preferably a series of independent and interchangeable mini-detectors (modular) with intercalated transport means (30), which makes it possible to change or modify the detectors in accordance with the speed at which the rods (1) circulate.

The transport means (30) of the rod (1) comprise a rated speed configured in accordance with a measurement precision established and a number of gamma detectors (21).

The gamma detectors (21) are independently configured from one another, allowing an individual assembly/dismantling of each gamma detector (21).

The identification block (60) comprises reading means (15) configured to read a rod identifier (1) and generate an identification of scanned rod (1″). The rod identifier (1) can be a rod code, an alphanumeric doe, or any type of identification that guarantees the identity of the rod (1). The identification block (60) enables controlling what rods (1) have been scanned and what the scanning result has been.

The scanner for fuel rods (1) comprises air-conditioning means (70) configured to generate operating conditions of the inspection means (10, 20, 60). The air-conditioning means (70) allow maintaining the inspection means (10, 20, 60) at a constant temperature.

The scanner for fuel rods (1) comprises fairing means (80) surrounding an inspection enclosure (81) configured to maintain operating conditions of the inspection means (10, 20, 60). The fairing means (80) may be configured to thermally confine the inspection means (10, 20, 60).

The scanner for fuel rods (1) comprises:
a) an auxiliary enclosure (82), contained in the fairing (80) and separated from the inspection enclosure (81) through separation means (83), containing the air-conditioning means (70); The auxiliary enclosure may also comprise a plurality of auxiliary elements for operation of the scanner such as electricity and other accessory equipment such as compressed air installations and data communication networks among others. The auxiliary enclosure (82) also houses the signal processing means (84);
b) an air-conditioning circuit configured to enable a circulation of air between the inspection enclosure (81) and the air-conditioning means (70). The air-conditioning circuit may comprise pipes (71) to drive the air conditioning air from the inspection enclosure (81) to the air-conditioning means (70) and vice-versa. Additionally, the air-conditioning circuit may comprise fans (72) to facilitate the circulation of the air conditioning air throughout the air-conditioning circuit. In one embodiment of the invention, it comprises two fans (72), a first fan (72) driving air from the inspection enclosure (81) and a second fan (72) aspirating air from the inspection enclosure (81).

The scanner for fuel rods (1) comprises: an acceptance basket (91) to receive admissible rods (1A); a rejection basket (92) to receive inadmissible rods (1N) and an inspection basket (93) to receive checkable rods (1R).

The scanner for fuel rods (1) comprises storage means (90) configured to store a result of a scan of each scanned rod (1″).

The scanner for fuel rods (1) is configured to scan fresh fuel rods (1) and/or be installed in a rod (1) production line.

A second aspect of the invention relates to a scanning method of fuel rods (1) comprising: inspecting by inspection means (10, 20, 60) a rod to be inspected (1′) to obtain a scanning result of a scanned rod (1″) and assigning a signal selected from admissible rod (1A), inadmissible rod (1N) and checkable rod (1R) to a scanned rod (1″) in accordance with the scanning result.

The scanner electronics box shall be preferably separated from the actual scanner.

The wiring of the drives and the sensors shall be internal to the motor unit module, from which only one external connector shall exit with the signals that will go to the electronics box.

The motor unit shall allow, once installed, its height adjustment by means of a gauge-based precision system.

The easy access, assembly and dismantling of all components without the fairing assembled is convenient, in particular of the motor unit with respect to the base.

Externally, it will incorporate a status LED strip (energy, forward, back, stoppage, . . . etc.) and sound or visual elements for cases of emergency or fault.

The scanner can be made in modular form, with each element forming part of a module which can be coupled to the others or placing the inspection means (10, 20, 60) and the auxiliary means in a single module.

1. Scanner for fuel rods comprising:
inspection means of rods;
transport means to displace the rod throughout the scanner;
characterized in that it comprises:
indicator means to generate a signal indicative of a result of a scan corresponding to a scanned rod;
auxiliary means selected from:
fairing means;
air-conditioning means
rod dust collection means;
signal processing means;
and combinations thereof

2. Scanner for fuel rods according to claim 1, wherein the indicative signal is selected from admissible rod, inadmissible rod and checkable rod.

3. Scanner for fuel rods according to claim 1, wherein the transport means of the rod comprise three or more drive points of the rod aligned according to a longitudinal axis parallel to a longitudinal axis of the rod

4. Scanner for fuel rods according to claim 3, wherein the drive points are distanced from one another by a distance less than one half of a length of the rod.

5. Scanner for fuel rods according to claim 4, wherein the distance is less than 600 mm.

6. Scanner for fuel rods according to claim 3, wherein the drive points are synchronized to guarantee uniformity in the drive of the rod.

7. Scanner for fuel rods according to claim 3, wherein at least one drive point comprises a rod passage detector.

8. Scanner for fuel rods according to claim 3, wherein the drive points comprise:
a pressure wheel configured to press the rod against; and
at least one driving wheel configured to drive the rod

9. Scanner for fuel rods according to claim 1, wherein the transport means of the rod comprise a rated speed configured to fulfil precision requirements in a scanning result.

10. Scanner for fuel rods according to claim 9, wherein the transport means of the rod comprise a speed selected from:
a re-scanning speed, slower than the rated speed;
a high speed, faster than the rated speed;
and combinations thereof.

11. Scanner for fuel rods according to claim 9, wherein the rated speed is 60 mm/s

12. Scanner for fuel rods according to claim 1, wherein the rod dust collection means are configured to collect dust from the rod generated in the scanner and obtain collected dust.

13. Scanner for fuel rods according to claim 12, wherein the dust collection means comprise a hopper underneath a drive point

14. Scanner for fuel rods according to claim 12, wherein the dust collection means comprise a pneumatic system configured to evacuate the collected dust.

15. Scanner for fuel rods according to claim 14, wherein the pneumatic system comprises:
a suction line configured to generate a suction in the hopper aspirating the collected dust obtaining suctioned dust;
an evacuation line configured to evacuate the suctioned dust.

16. Scanner for fuel rods according to claim 1, wherein the inspection means comprise a block selected from:
an instrumentation block;
a gamma block;
an identification block;
and combinations thereof.

17. Scanner for fuel rods according to claim 15, wherein the instrumentation block comprises a device selected from:
at a densitometer;
a gadolinium meter ;
a fault detector for detecting faults in the container tube;
a profilometer;
and combinations thereof.

18. Scanner for fuel rods according to claim 17, wherein the densitometer comprises a source of gamma radiation configured to obtain an x-ray of the rod.

19. Scanner for fuel rods according to claim 17, wherein the gadolinium meter comprises:
at a magnetic generator to generate a magnetic field;
a first induction current generator to detect induction currents generated by the magnetic field.

20. Scanner for fuel rods according to claim 17, wherein the fault detector comprises:
at a current generator to generate induction currents in the fuel rod;
a second induction current generator to detect induction currents generated in the fuel rod.

21. Scanner for fuel rods according to claim 17, wherein the profilometer comprises four laser emitters disposed to measure four diameters in four different directions of the fuel rod.

22. Scanner for fuel rods according to claim 16, wherein the gamma block comprises a plurality of electronically synchronized gamma detectors.

23. Scanner for fuel rods according to claim 22, wherein the transport means of the rod comprise a rated speed configured in accordance with a measurement precision established and a number of gamma detectors

24. Scanner for fuel rods according to claim 22, wherein the gamma detectors are independently configured from one another, allowing an individual assembly/dismantling of each gamma detector.

25. Scanner for fuel rods according to claim 22, where the plurality of gamma detectors is a series of independent and interchangeable mini-detectors with intercalated transport means.

26. Scanner for fuel rods according to claim 16, wherein the identification block comprises reading means configured to read a rod identifier and generate a scanned rod identification.

27. Scanner for fuel rods according to claim 1, comprising air-conditioning means configured to generate operating conditions of the inspection means.

28. Scanner for fuel rods according to claim 1, comprising fairing means surrounding an inspection enclosure configured to maintain the operating conditions of the inspection means.

29. Scanner for fuel rods according to claim 28, comprising:
at an auxiliary enclosure;
containing the air-conditioning means;
contained in the fairing;
separated from the inspection enclosure through separation means;
an air-conditioning circuit configured to enable a circulation of air between the inspection enclosure and the air-conditioning means.

30. Scanner for fuel rods according to claim 1, comprising:
an acceptance basket to receive admissible rods,
a rejection basket to receive inadmissible rods.
an inspection basket to receive checkable rods.

31. Scanner for fuel rods according to claim 1, comprising storage means configured to store a result of a scan of each scanned rod.

32. Scanner for fuel rods according to claim 1, wherein it is configured to scan fresh fuel rods.

33. Scanner for fuel rods according to claim 1, wherein it is configured to be installed in a rod production line.

34. Scanning method of fuel rods comprising:
at inspecting by inspection means a rod to be inspected to obtain a scanning result of a scanned rod;
assigning a signal selected from admissible rod, inadmissible rod and checkable rod to a scanned rod in accordance with the scanning result.
